(19) United States
(12) Patent Application Publication
(10) Pub. No.: US 2009/0250882 A1
(43) Pub. Date: Oct. 8, 2009

(54) Seal Assembly and Corresponding Method for Sealing

(75) Inventor: David Christopher Sampson, West Yorkshire (GB)

Correspondence Address: HARNESS, DICKEY & PIERCE, P.L.C., P.O. BOX 828, BLOOMFIELD HILLS, MI, 48303, US

(73) Assignee: FTL SEALS TECHNOLOGY LIMITED, LEEDS (GB)

(21) Appl. No.: 12/084,313

(22) PCT Filed: Oct. 31, 2006
(86) PCT No.: PCT/GB2006/004061

§ 371 Date: May 19, 2009

(30) Foreign Application Priority Data
Nov. 1, 2005 (GB) 0522220.3

(51) Int. Cl. F16J 15/32

(52) U.S. Cl. 277/569

(57) ABSTRACT

A seal assembly is disclosed which has a first elastomeric sealing member (11) for sealing a lubricating environment and a second non-elastomeric sealing member (13) side-by-side with the first sealing member for sealing a non-lubricated environment. The first sealing member (11) includes a sealing lip (15) having a sealing surface (16) and a generally U-shaped reinforced member (20) for supporting the sealing lip at a desired location.

The present invention relates to a seal assembly and corresponding method for providing a seal. In particular, but not exclusively, the present invention relates to a sealing system suitable for use in a dynamic sealing application wherein a lubricating fluid, at or near to atmospheric pressure, must be separated from substantially dry air at above atmospheric pressure. An example of such an application is a central tyre inflation (CTI) apparatus.

CTI systems are commonly found on drive/steer axles in off road or off highway vehicles where the need to both inflate and deflate the tyre whilst moving is necessary, e.g. military vehicles and emergency vehicles. Generally, when very large off highway vehicles, such as military vehicles, forestry vehicles, earth moving equipment, fire tenders, etc, leave the highway and drive onto poor ground conditions, it is desirable to increase the “footprint” of the tyre by deflating the tyre. Similarly, when the vehicle returns to the highway it is desirable to reinflate the tyre.

Many drive axles fitted with integral CTI systems are described in the literature. For instance, U.S. Pat. No. 5,174,839 shows such an axle consisting of a shaft with sleeve and a rotatable hub assembly, the parts separated by a pair of taper roller bearings. Air, under pressure, is introduced into the rotating hub, which carries the road wheel/tyre unit, through the annular space that occurs between the two inwardly facing taper roller bearings by an air passageway that is machined into the non rotating shaft.

It is necessary in the interests of serviceability and bearing life to ensure that the taper roller bearings receive an adequate supply of lubricant. This normally takes the form of grease and/or oil or other such lubricating fluid. It is normal practice for the bearing lubricating medium to be at a pressure approximately equal to that of standard atmospheric pressure (760 mm Hg or 1013 mb).

It is common practice for the lubricating medium to be kept within the confines of the bearing by the use of a radial shaft seal, normally of an elastomeric material, of which the outer diameter being a push fit into the rotating hub, and the inner sealing diameter of the seal slidably contacting a rotating sleeve which in turn is mounted on the shaft.

By the very fact that the air used to inflate the tyre of the vehicle must be greater than atmospheric pressure and often as high as ten times atmospheric pressure (1 MPa) then the pressurised air must be separated within the CTI assembly by yet a further radial shaft seal.

As previously stated as it is common practice to install two inwardly facing sets of taper rolling bearings to carry the radial load imposed by the wheel/tyre assembly and introduced the pressurised air between the bearings into the resulting annular space. However, in such an arrangement, it is necessary to have two radial sealing devices for the lubricant and two sets of radial sealing devices for the air, giving rise to a requirement for four seals for each axle.

Furthermore, it is common for those well practised in the art to incorporate the two sealing lips of the radial sealing devices into one radial seal unit, a so called “twin lipped” radial seal. There being the need to have two such radial seals, in such a CTI system, this results in four radial sealing lips. One outer pair to seal the lubricating medium into the bearing units and one inner pair to seal the pressurised air into the annular space between the bearing units.

Thus existing CTI seal assemblies are expensive to manufacture and provide and time consuming to position on an axle.

Furthermore it is custom and practice to manufacture the sealing lips from an elastomeric material such as an acrylic elastomer material (ACM). By its very nature the elastomer, in an unlubricated environment, exhibits relatively high amounts of friction load when in contact with a dynamic metallic surface. In the lubricated environment of the taper roller bearings this does not present a problem as bearing lubricant also lubricates the seal lip helping to reduce frictional load and remove heat that is generated.

However, the “air” sealing lip works in an environment with little or no lubricating medium at all. The absence of lubricant means that the friction load on the air sealing lip is high. Furthermore, the friction load on the air sealing lip is increased by the standard procedure of fitting a small toroidal spring to assist the seal lip in maintaining contact with the rotating sleeve.

As the sealing lip is often an elastomer running against a dynamic rotating metallic surface in an unlubricated state, due, inter alia, to the high friction load on the sealing lip, rapid heat build up can and does occur leading to premature seal lip failure. It has also been noted that particulate material can be produced which can hinder the sealing process.

In addition, a further reason for seal lip failure is due to the pressure experienced by the tip of the lip when the seal is positioned on the shaft.

It is an aim of the present invention to at least partly mitigate the above-mentioned problem.

It is an aim of embodiments of the present invention to provide a seal assembly in which a sealing lip is constantly urged against a sealing surface so as to provide improved sealing characteristics.

It is an aim of embodiments of the present invention to provide a seal assembly in which particulate matter from a dry side of the seal is prevented from compromising sealing.

It is an aim of embodiments of the present invention to provide a method of sealing a rotating body from a stationary body in which one side of the seal experiences fluid at low pressure whilst the further side of the seal experiences dry air conditions under high pressure. The method includes the steps of providing a first elastomeric sealing member including a reinforcement member for supporting a sealing lip at a desired location.

Preferably a seal assembly is provided which comprises a first low coefficient of friction portion and a second.

In a preferred aspect of the invention the low coefficient of friction portion comprises a non-elastomeric material, such as a thermoset plastic material. An example of such a material is a fluorinated polymer, such as PTFE.

The value of the coefficient of friction may vary depending upon, inter alia, the nature of the material, the load, etc. However, preferably the coefficient of friction may be in the range of from 0.15 to 0.25 under unlubricated running conditions.

Preferably the low coefficient of friction portion comprises a lip seal.

In a preferred aspect of the invention the first oil resistant portion comprises an elastomeric material, such as acrylic elastomer (ACM), nitrile elastomer (NBR), or fluorine elastomer (FPM).

The value of the coefficient of friction of the oil resistant portion of the seal may also vary depending upon, inter alia, the nature of the material, the load, etc. However, preferably the coefficient of friction may be in the range of from 0.25 to 0.5 under unlubricated running conditions.

Preferably the low coefficient of friction portion comprises a shaft seal.

The seal assembly of the invention may therefore comprise a shaft seal portion and a lip seal portion. It is within the scope of the present invention for the shaft seal portion and lip seal portion to be separate and, optionally presented together in a seal housing. However, preferably the shaft seal portion and a lip seal portion are joined as an integral seal.

As hereinbefore described the seal assembly of the invention may have a variety of uses, where a lubricant and pressurised gas interface is present. However, the seal assembly of the invention is especially suited for use as a CTI seal.

The seal may be suitable for sealing rotating shafts with a cylindrical surface e.g. a bearing journal for instance. The diameter range suitable for such a seal is unlimited but is likely to be in a range of 10 mm to 200 mm.

According to a further aspect of the invention there is provided a method of forming a seal between fluid and a pressurised gas which comprises the use of a seal assembly as hereinbefore described.

Preferably the method comprises forming a seal around an axle, such as a vehicle axle.

Advantageously there is provided a method of central tyre inflation which comprises the use of a seal assembly as hereinbefore described.

Conveniently there is provided a central tyre inflation system which comprises a seal assembly as hereinbefore described.

Preferably there is provided the use of a shaft seal portion and the lip seal portion in the manufacture of a seal assembly as hereinbefore described. According to this aspect of the invention we especially provide the use of a shaft seal portion and the lip seal portion in the manufacture of a seal assembly as hereinbefore described.

According to a further embodiment of the invention there is provided a wheel drive axle assembly fitted with seal assembly as hereinbefore described.

Conveniently there is also provided a vehicle fitted with a seal assembly as hereinbefore described.

The invention will now be described hereinafter, by way of example only, with reference to the accompanying drawings, in which:

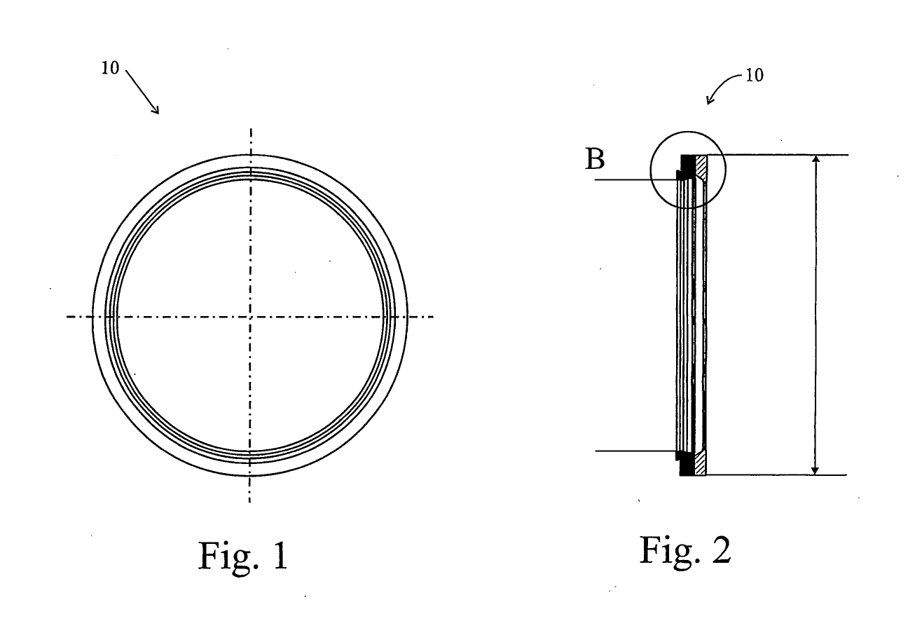

FIG. 1 is a schematic representation of a seal of the invention;

FIG. 2 is a cross section of the seal of FIG. 1; and

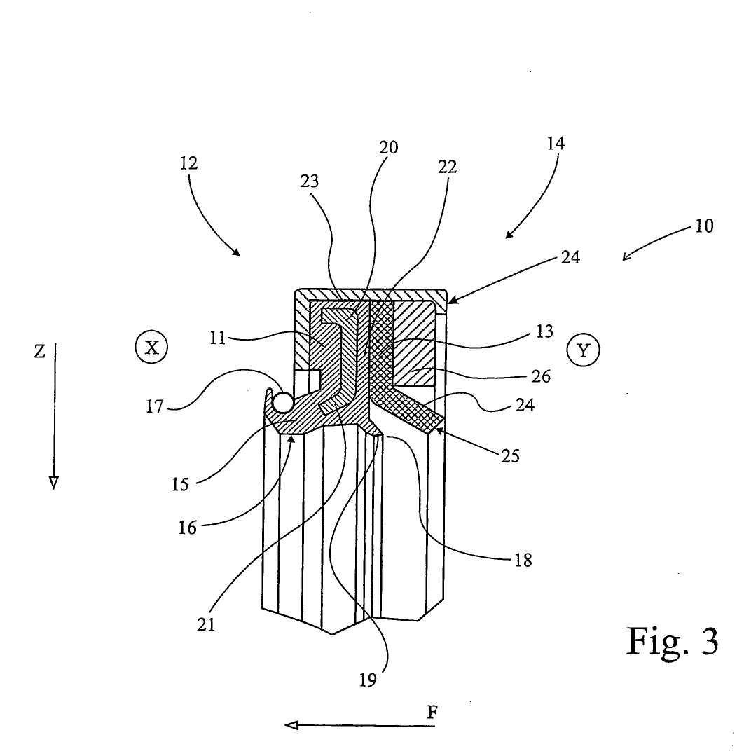

FIG. 3 is an enlarged close up view of the cross section of FIG. 2.

In the drawings like reference numerals refer to like parts.

FIG. 1 illustrates a seal assembly 10 in accordance with an embodiment of the present invention. The seal assembly is generally circular so as to form a ring-like seal assembly.

FIG. 2 illustrates a side view of the seal assembly 10. A close up through the section B is illustrated more clearly in FIG. 3. As seen in FIG. 3 the seal assembly includes an elastomeric sealing member 11 for sealing a lubricated environment (generally designated by region X adjacent to one side region 12 of the seal assembly). The seal assembly 10 further includes a second sealing member 13 which is located in a side-by-side configuration with the first sealing member 11. The second sealing member 13 is arranged for sealing a non-lubricated environment generally designated Y which is adjacent to a second side region 14 of the seal assembly.

The first sealing member 11 is generally a reverse L-shaped elastomeric body including a sealing lip extension 15 having a sealing surface region 16. This surface is urged downwardly in the direction illustrated by arrow Z in FIG. 3 which corresponds to movement caused by pressure radially inwardly so as to urge the sealing surface 16 against a juxtaposed target surface (not shown). The urging force is provided by a circular spring member 17 or other such biasing element which sits in a U-shaped channel extending circumferentially around an upper region of the sealing lip of the first sealing member 11.

The first sealing member 11 also includes a further lip 18 which acts as a “dust” lip. The dust lip 18 is directed away from the sealing surface of the first sealing member and has a lower contact surface 19 which is arranged to also contact the juxtaposed target surface.

A generally U-shaped reinforcement member 20 is located within the first sealing member and performs a number of functions. The reinforcement member is formed from metal or some other rigid/semi rigid material. The reinforcement member provides rigidity for the first sealing member which will generally be an elastomeric member so that the seal assembly can be constructed and handled. A first side wing 21 extends along the sealing lip of the first sealing member so as to help prevent the sealing lip 15 from being “flipped” inside out. This flipping motion tends to occur because of the presence of a vacuum condition on the right-hand side region Y. The vacuum occurs because CTI systems operate in conjunction with wheel valves which allow inflation/deflation through a single hub air passage. Some control systems actuate the valves by means of a 100 mb (abs) vacuum.

The first sealing member also includes a first sealing ridge 22 which extends along a side of the sealing member so as to form a seal between the first sealing member and the second sealing member 13. A further sealing ridge 23 extends around the first sealing member and forms a good seal with a housing 24. The housing may be formed from a pressed and ground metal outer housing which is of such diametrical dimensions as to be an interference fit in its retaining housing (not shown) in accordance with ISO 286-2.

The second sealing member is formed as a doglegged wall structure including a first portion running substantially along the length of the first sealing member whilst the end region 24 forming the dogleg ends in a contact edge 25 for running on a juxtaposed target surface. The second sealing member also includes a metal ring 26 which acts as a spacer for the seal assembly.

The first sealing member forms an elastomeric radial shaft seal whilst the second sealing member provides a thermoset plastic radial shaft seal. The purpose of the elastomeric radial shaft seal is to keep the lubricating medium in the bearing area X by the action of the seal lip 15 and the purpose of the thermoset plastic radial shaft seal is to keep the pressurised air in the annular space Y by the action of the seal lip 25. Both seal lips operate in sliding contact with a rotating shaft sleeve (not shown).

The elastomeric radial shaft seal 11 is a compression moulded item that is made from a suitable oil resistant elastomer such as acrylic elastomer (ACM) but may be made from any suitable material such as nitrile elastomer (NBR) or fluorine elastomer (FPM).

The thermoset plastic radial shaft seal may be made from a filled fluorine plastic compound such as polytetra fluorethylene (PTFE).

Those skilled in the art will appreciate that thermoset fluorine based plastic such as PTFE has several outstanding mechanical properties in relation to sealing in low/no lubrication regimes. Specifically, a very low coefficient of friction is provided of approximately 0.1 when unlubricated. Conversely there are some less desirable mechanical properties such as the tendency to “cold flow”. This is undesirable in a sealing element as we wish it to retain it's originally designed profile and shape. By the careful addition of different materials during the compounding stage of manufacture the material properties of the thermoset plastic can be optimised for the specific application.

The low coefficient of friction for generating low friction loads in unlubricated applications in the CTI application provides a notable advantage. As the presence of oil in the compressed air system may lead to contamination of the tyre assembly, into which the air will eventually pass, the manufacturer of the drive axle, or other assembly, will ensure that the compressed air is in an oil free state as possible.

A further advantage of the use of the PTFE compound for the dry running seal over the more traditional elastomeric seal material (which has a much higher coefficient of friction) is that as the pressure of the air can be at up to ten times that of atmospheric pressure then the load induced upon the seal lip by the air pressure is proportionately ten timers higher. This would result in the friction load for an elastomeric sealing lip being much higher than that of an identical PTFE sealing lip.

To help prevent the ingress of particulate matter which can otherwise occur during warm up of the lip 25 of the second sealing member the second elastomeric sealing member includes the dust lip 19. This prevents particulate matter formed by the abrasion of the sealing lip 25 from moving in the direction illustrated by arrow F so as to collect between the sealing surface 16 and a juxtaposed target surface. Such particulate matter would compromise the sealing operation.

When forming the seal assembly the elastomeric radial shaft seal is positioned next to the thermoset plastic radial shaft air seal and locked into place by the metal housing (24) being hydraulically “headed over” to retain all the elements securely within the seal housing (24).

To ensure that a leak path does not occur between elastomeric radial shaft seal (11) and thermoset plastic radial seal (13) a small sealing feature (22) is moulded onto the rear face of the elastomeric seal. A further static sealing feature (23) is moulded onto the outer diameter of the seal to reduce the risk of lubricating oil passing through the space between seal outer diameter and metal housing (24).

Embodiments of the present invention provide an advantageous seal assembly which can seal a fluid lubricated side and non-lubricated side whilst maintaining a good seal. Flipping of the seal is prevented and particulate matter is prevented from ingress into a sealing location.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A seal assembly, comprising:
a first elastomeric sealing member for sealing a lubricating environment adjacent a first side region of the seal assembly; and
a second non-elastomeric sealing member, disposed in a side-by-side arrangement with said first sealing member, for sealing a non-lubricated environment adjacent to a second side region of the seal assembly; wherein
said first sealing member comprises a sealing lip having a sealing surface and a generally U-shaped reinforcement member for supporting said sealing lip at a desired location.

2. The seal assembly as claimed in claim 1, further comprising:
said U-shaped reinforcing member is aligned in said first sealing member whereby a first end region of the reinforcing member is disposed proximate to said sealing lip and a second end region of said reinforcing member is disposed proximate to a metal housing of said seal assembly.

3. The seal assembly as claimed in claim 1, further comprising:
a further lip member for preventing ingress of particulate matter, from the second side region of the seal assembly, between the sealing surface and a juxtaposed target surface.

4. The seal assembly as claimed in claim 3, wherein said further lip member is curved towards said second side region.

5. The seal assembly as claimed in claim 1, further comprising:
a first sealing ridge for sealing a side region of the first sealing member to a mating side of said second sealing member.

6. The seal assembly as claimed in claim 1, wherein said first sealing member further comprises:
a second sealing ridge for sealing a top side of said first sealing member against a metal housing of said seal assembly.

7. The seal assembly as claimed in claim 1, further comprising:
a spring element for urging the sealing surface towards a juxtaposed target surface.

8. The seal assembly as claimed in claim 1, wherein said second sealing member comprises a low coefficient of friction member having a coefficient of friction between 0.15 and 0.25 under unlubricated running conditions.

9. The seal assembly as claimed in claim 8, wherein said second sealing member comprises a thermostat plastic material.

10. The seal assembly as claimed in claim 9, wherein said thermostat plastic material comprises a fluorinated polymer.

11. The seal assembly as claimed in claim 1, wherein said seal is beatable in a CTI system.

12. The seal assembly as claimed in claim 1, further comprising a housing for supporting said first and second sealing members in a side-by-side arrangement.

13. (canceled)

14. (canceled)
